(19) United States
(12) Patent Application Publication
(10) Pub. No.: US 2007/0064222 A1
(43) Pub. Date: Mar. 22, 2007

(54) Systems and methods for testing and inspecting optical instruments

(75) Inventor: Robert A. Schlachter, Clearwater, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/230,345

(22) Filed: Sep. 20, 2005

(51) Int. Cl. G01B 9/00

(52) U.S. Cl. 356/124

(57) ABSTRACT

Systems and methods for testing and inspecting optical instruments are presented. In one embodiment, an optical instrument comprises a tubular housing having an aperture end and an observing end, wherein the aperture end is adapted to allow light to enter and exit the tubular housing. The optical instrument further comprises at least one optical element for focusing light, wherein the at least one optical element for focusing light is adapted to focus collimated light entering the aperture end at a focal point; an optical detector adapted to receive the focused collimated light; and a light emitting device coupled to the optical detector and located at the focal point.

### TECHNICAL FIELD

The present invention generally relates to optical devices and more particularly to the testing and inspection of optical instruments.

### BACKGROUND

Optical instruments used to observe distant objects, such as star trackers, celestial sensors and telescopes, are frequently difficult to focus and difficult to inspect for shifts or degradations in internal components. Existing methods using interferometers and calibrated light sources are time consuming, require considerable assembly, and add significant labor and material costs.

For the reasons stated above and for other reasons stated below which will become apparent to those skilled in the art upon reading and understanding the specification, there is a need in the art for improved systems and methods for testing and inspecting optical instruments.

### SUMMARY

The Embodiments of the present invention provide methods and systems for testing and inspecting optical instruments and will be understood by reading and studying the following specification.

In one embodiment, an optical instrument is provided, the optical instrument comprises a tubular housing having an aperture end and an observing end, wherein the aperture end is adapted to allow light to enter and exit the tubular housing; at least one optical element for focusing light, wherein the at least one optical element for focusing light is adapted to focus collimated light entering the aperture end at a focal point; an optical detector adapted to receive the focused collimated light; and a light emitting device coupled to the optical detector and located at the focal point.

In another embodiment, a method for testing an optical instrument is provided. The method comprises illuminating a light emitting device located on an optical detector at a focal point of an optical instrument, the optical instrument having an aperture end adapted to allow light to enter and exit the optical instrument.

In yet another embodiment, an optical instrument is provided. The instrument comprises means for collecting within a housing light from a distant light source; means for focusing the collected light from the distant light source at a focal point within the housing; means for detecting the light collected from the distant light source and focused at the focal point within the housing; and means for emitting light at the focal point within the housing for testing the optical instrument.

### BRIEF DESCRIPTION OF THE DRAWINGS

The present invention can be more easily understood and further advantages and uses thereof more readily apparent, when considered in view of the description of the preferred embodiments and the following figures in which:

FIG. 1 is a diagram illustrating an optical instrument of one embodiment of the present invention;

FIG. 2A is a diagram illustrating one embodiment of the present invention;

FIG. 2B is a flow chart illustrating a method of one embodiment of the present invention;

FIGS. 3A and 3B are diagrams illustrating embodiments of the present invention;

FIGS. 3C and 3D are flow charts illustrating methods of embodiments of the present invention;

FIG. 4A is a diagram illustrating one embodiment of the present invention;

FIG. 4B is a flow chart illustrating a method of one embodiment of the present invention;

FIG. 5A is a diagram illustrating one embodiment of the present invention;

FIG. 5B is a flow chart illustrating a method of one embodiment of the present invention;

FIG. 6A is a diagram illustrating one embodiment of the present invention; and

FIG. 6B is a flow chart illustrating a method of one embodiment of the present invention.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

Embodiments of the present invention provide systems and methods for performing focus testing, performance testing, functional testing and alignment testing of optical instruments, as is detailed in the following description. Embodiments of the present invention further provide systems and methods for visually inspecting the interior mechanisms of an optical instrument, and for using an optical instrument as a collimated light source. Although embodiments of the present invention are illustrated in this specification by describing reflective optical elements, one skilled in the art upon reading this specification will appreciate that embodiments of the present invention are not limited to reflective optical elements but also apply to optical instruments utilizing refractive optical elements such as optical lenses, or optical instruments having a combination of both reflective and refractive optical elements.

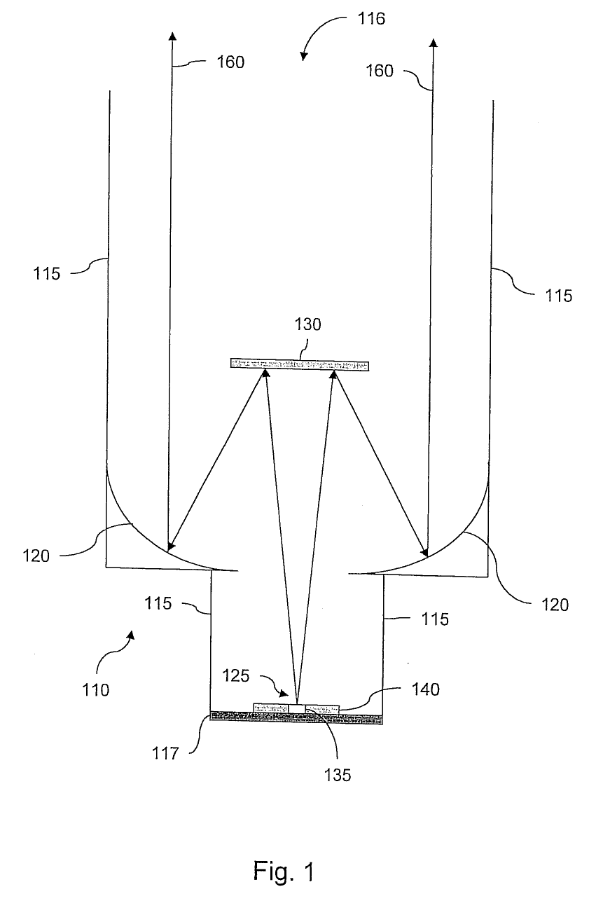

FIG. 1 illustrates of an optical instrument 110 of one embodiment of the present invention. Optical instrument 110 comprises a tubular housing 115 having an aperture end 116 and an observing end 117. Aperture end 116 is adapted to allow light to enter and exit tubular housing 115. In one embodiment, optical instrument 110 further comprises a first reflective surface 120 shaped to focus collimated light entering tubular housing 115 at a focal point 125. In one embodiment, first reflective surface 120 is a paraboloidal mirror. Paraboloidal mirrors are frequently used in astronomical applications to focus the essentially parallel light rays emanating from distant objects, such as stars, to a single focal point. In one embodiment, optical instrument 110 further comprises a second reflective surface 130 which, as would be appreciated by one skilled in the art upon reading this specification, serves the purpose of achieving a longer optical focal length for optical instrument 110 without the need to extend the physical dimensions of tubular housing 115. In one embodiment, second reflecting surface 130 further serves to redirect focal point 125 to a position at or near observing end 117 of tubular housing 115. Optical instrument 110 further comprises an optical detector 140 located at focal point 125 such that collimated light from a distant object will focus to create an image of the distant object on optical detector 140. Optical detector 140 outputs one or more signals based on light it receives. In one embodiment, optical detector 140 outputs signals representing, but not limited to, one or more of luminosity and chrominance of light received by optical detector 140.

In one embodiment, optical instrument 110 is an instrument used for collecting and analyzing light, such as, but not limited to, a telescope, a microscope, a celestial sensor, a star tracker and an image capturing device. In one embodiment, optical instrument 110 is an image capturing device such as, but not limited to a CCD camera.

Embodiments of an optical instrument 110 of the present invention include the placement of a light emitting device (LED) 135 at focal point 125. In one embodiment LED 135 is integrated into optical detector 140. LED 135 should be physically small in surface area, relative to the surface area of optical detector 140, so as not to significantly reduce the light detecting capacity of optical detector 140. In one embodiment, LED 135 is a light emitting diode. Because of the optical qualities of optical instrument 110 described above, LED 135 located at focal point 125 will generate an output of collimated light 160 at aperture end 116. In this configuration, optical instrument 110 is a collimated light source that, in one embodiment, is used as a testing instrument for another device requiring a collimated light input.

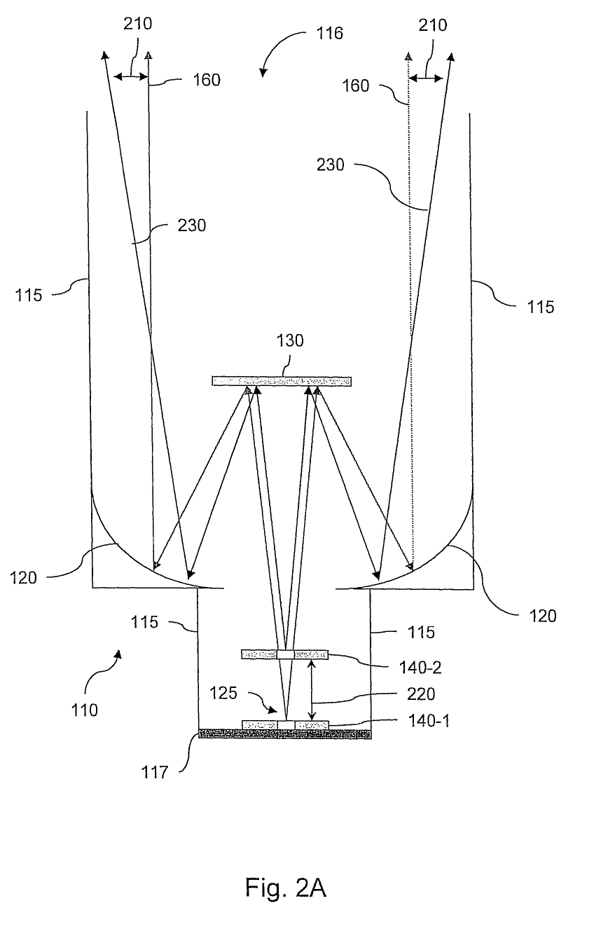

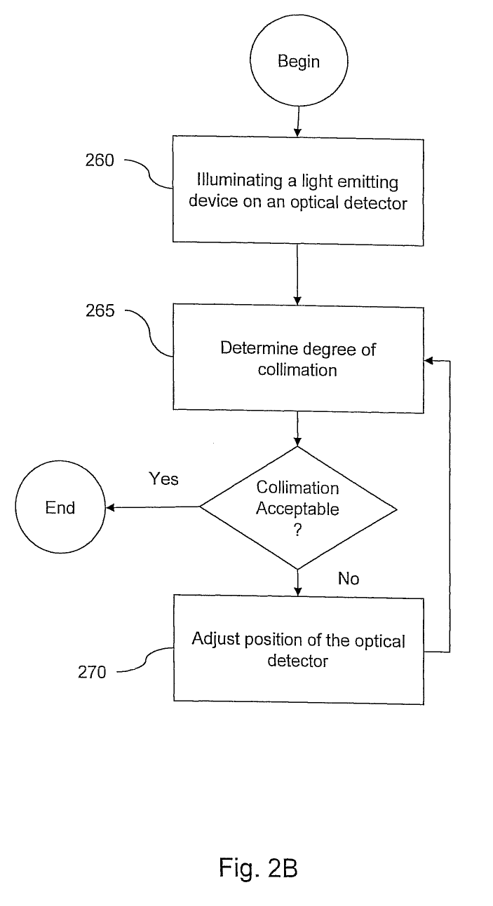

FIGS. 2A and 2B illustrate one embodiment of a method for focusing an optical instrument, such as optical instrument 110 of FIG. 1. As illustrated in FIG. 2A, when optical detector 140 (with integrated LED 135), is located at focal point 125 (indicated at 140-1), light emitted by LED 135 will exit aperture end 116 as collimated light 160. In contrast, when optical detector 140 (with integrated LED 135), is located in a position other than focal point 125 (indicated at 140-2), light emitted by LED 135 will exit aperture end 116 as non-collimated light 230. The elevation (or angle) of non-collimation 210 is a function of the degree of deviation of detector 140 from focal point 125 (shown by 220).

Based on this relationship, FIG. 2B illustrates a method of one embodiment of the present invention for focusing an optical instrument. The method begins at 260 with illuminating a light emitting device located on an optical detector of an optical instrument. The method continues to 265 with determining the degree of collimation of light exiting the aperture end of the optical instrument. In one embodiment, the degree of collimation can be determined by measuring an elevation of the light exiting the aperture end at two or more location with a theodolite. The differences in elevation provide the degree of collimation. When the degree of collimation is not acceptable, the method proceeds to 270 with adjusting the position of the optical detector. After the position of the optical detector is adjusted, the method returns to 265 to again determine the degree of collimation. In one embodiment, the position of the optical detector is adjusted until the required degree of collimation is achieved. The acceptable degree of collimation will vary based on the precision required for the end use application for the optical instrument. For example, an amateur telescope may require a lesser degree of collimation for adequate performance than a star tracker utilized for an orbiting satellite's attitude control system. As described above, when the light emitting device is located precisely at the focal point of the optical instrument, the light leaving the aperture end will have the highest degree of collimation. The descriptions within this specification refer to one or both of the location and orientation of the detector element of the instrument. However, those skilled in the art upon reading this specification would appreciate that the scope of embodiments of the present invention envelopes any adjustment in effective focal length made by adjusting other elements in the optic train.

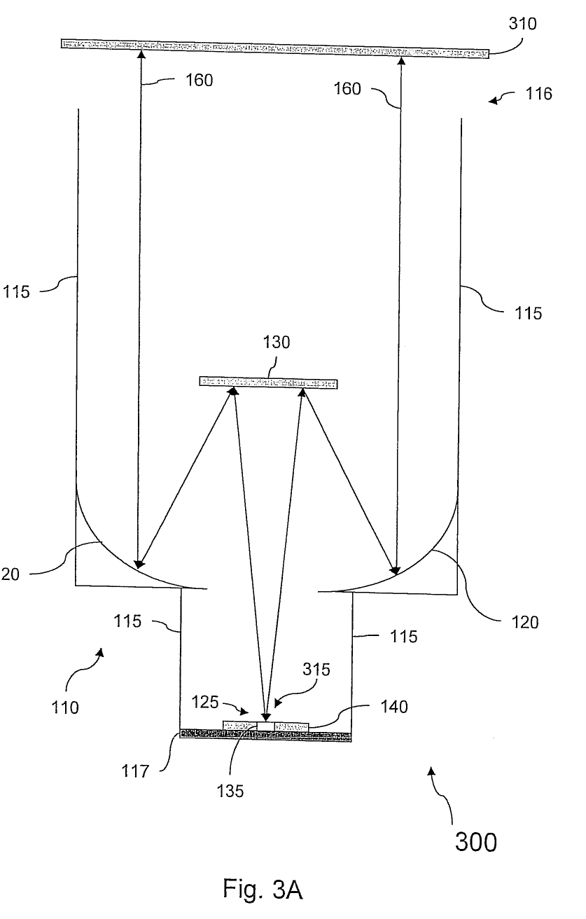

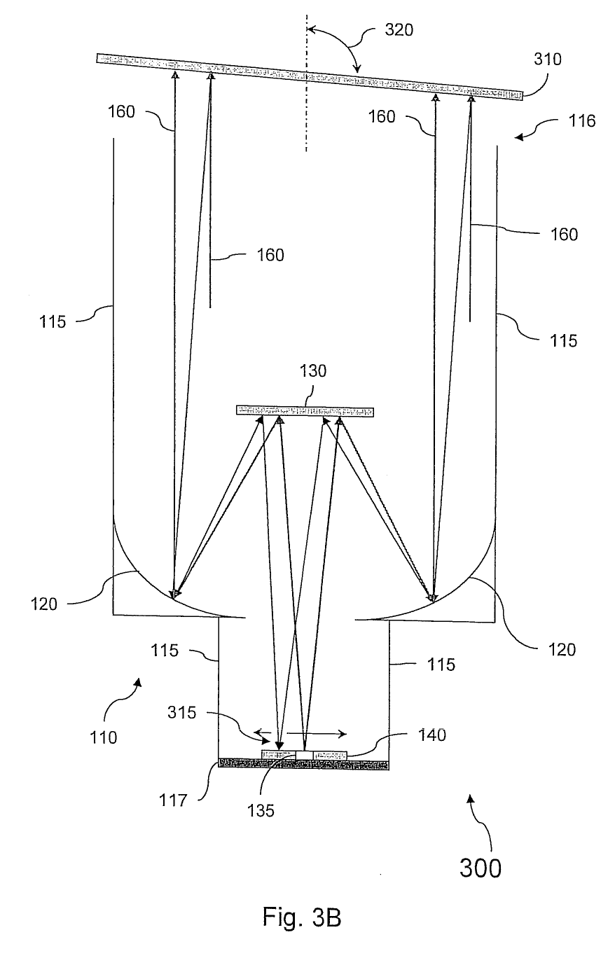

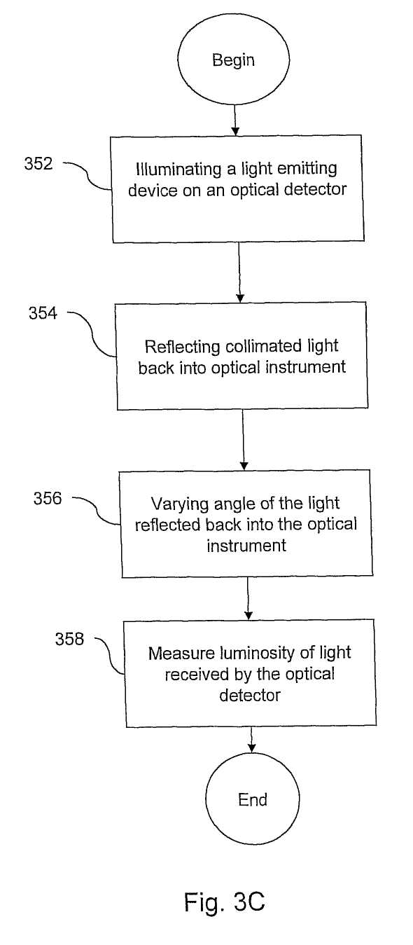

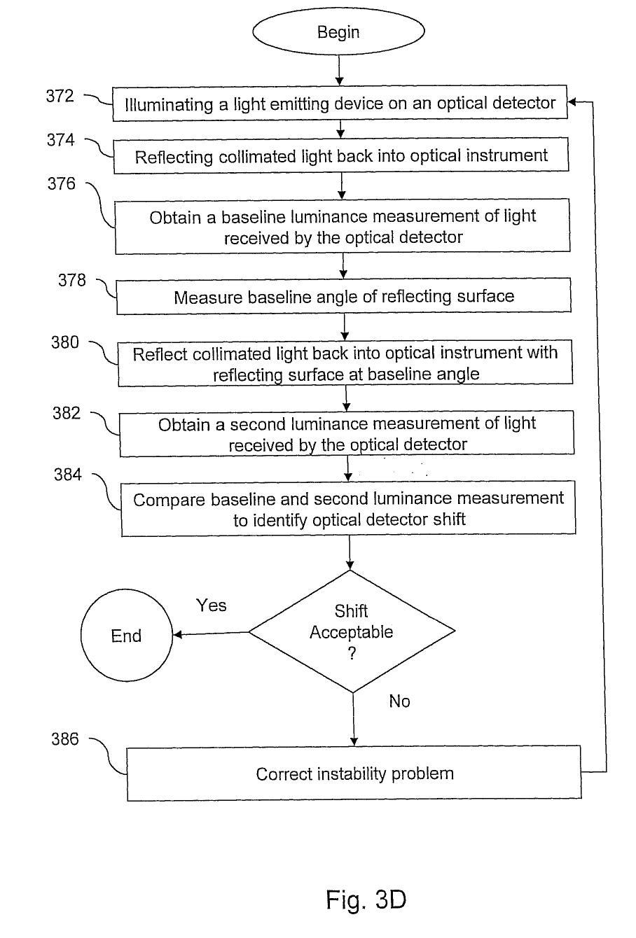

FIGS. 3A, 3B and 3C illustrate one embodiment of a method for performance testing of an optical instrument, such as optical instrument 110 of FIG. 1. As illustrated in FIG. 3A, when optical detector 140 (with integrated LED 135) is located at focal point 125, light emitted by LED 135 will exit aperture end 116 as collimated light 160. Embodiment 300 includes a third reflective surface 310 that reflects the collimated light 160 back into the aperture end 116 of optical instrument 110 to form a reflected image 315 on optical detector 140. When third reflective surface 310 is normal to the collimated light 160, reflected image 315 substantially falls on LED 135. By observing optical detector 140 output signals as the reflected image 315 is redirected to various parts of optical detector 140, the image quality of optical detector 140 can be determined. Illustrated in FIG. 3B, the position of the reflected image 315 can be redirected to various parts of optical detector 140 by rotating the angle 320 of third reflective surface 310 with respect to collimated light 160.

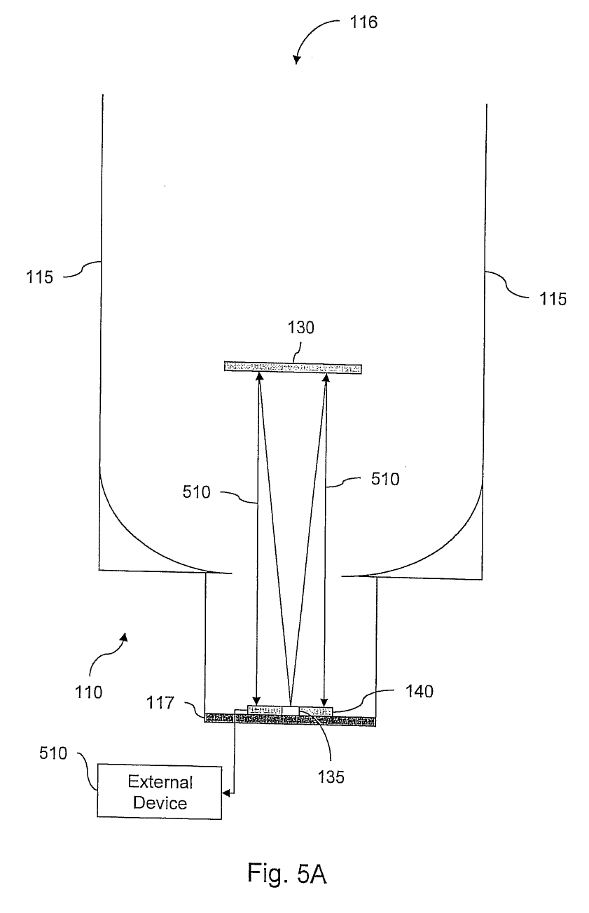

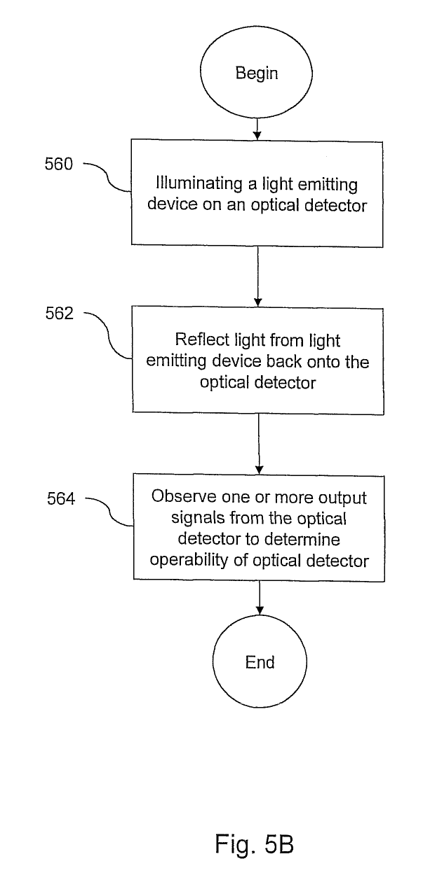

FIG. 3C illustrates a method of one embodiment of the present invention for performing a performance test on an optical instrument. The method begins at 352 with illuminating a light emitting device located on an optical detector of an optical instrument. Assuming that the optical instrument is properly in focus, collimated light will exit the aperture end of the optical instrument. The method continues at 354 with reflecting the collimated light back into the optical instrument to form an image on an optical detector located at the focal point of the optical instrument. The method continues at 356 with varying an angle of the light reflected back into the optical instrument to redirect the location of the image on the optical detector. The luminosity of light received by the optical detector is measured (358) at each location to identify defects with the optical detector. In one embodiment, the light received by the optical detector simulates star images for optical instrument performance testing as described above, or optical instrument functional testing as described with respect to FIG. 5B below.

FIG. 3D illustrated a method for measuring lateral and rotational detector shifts within optical instruments of embodiments of the present invention. Detector shifts can occur when elements within the optical instrument move over time or due to changing environmental conditions such as temperatures, vibration, stress relief and fatigue. The method first comprises obtaining baseline measurements to establish a baseline detector position. To obtain the baseline measurement, the method begins at 372 with illuminating a light emitting device located on an optical detector of an optical instrument. The method continues at 374 with reflecting the collimated light back into the optical instrument to form an image on an optical detector located at the focal point of the optical instrument. The luminance of the light received by the optical detector is then measured (376). The method then proceeds to 378 with measuring an angle of a reflecting surface used to reflect the collimated light back into the optical instrument with respect to a fixed reference. The optical instrument can then be relocated or used in its normal function. The luminance and reflecting surface angle measurements establish respective baseline luminance and angle measurements which can be subsequently referenced to determine when a detector shift has occurred.

To subsequently determine when a detector shift has occurred, the method proceeds with again reflecting collimated light back into the optical instrument (380) with a reflective surface oriented to the baseline angle. Next, the method proceeds to 382 with obtaining a second luminance measurement of light received by the optical detector (382). A difference between the second luminance measurement and the baseline luminance measurement indicate a lateral shift of the optical detector. Therefore, the method continues to 384 with comparing the baseline and second luminance measurements. When the difference in luminance measurements indicates an unacceptable lateral shift of the optical detector, the instability of the optical instrument is corrected at 386. The method then returns to 372.

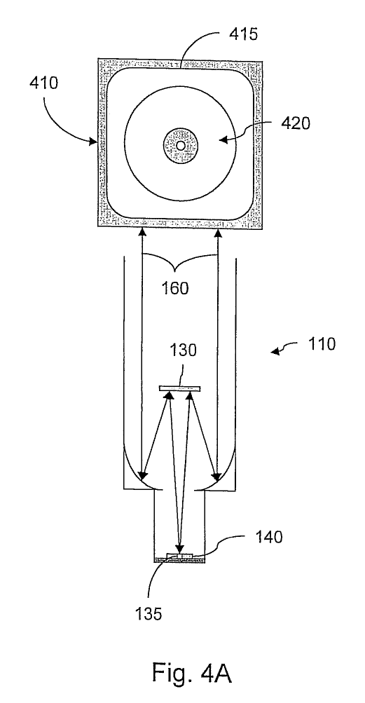

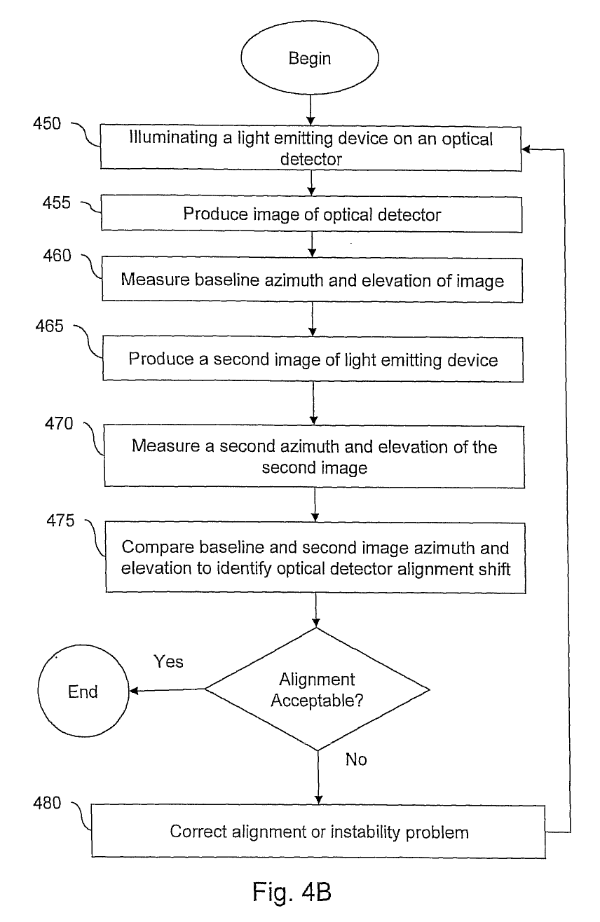

In one embodiment, the collimated light output from optical instrument 110 is measured to determine the alignment of optical detector 140 and measure lateral shifts, as illustrated by FIGS. 4A and 4B. In one embodiment, optical instrument 110's boresight angle, also known as the “line of sight” angle, is measured to determine the alignment of optical detector 140 instead of mapping the full detector. An alignment device 410, such as a theodolite, receives the collimated light 160 exiting optical instrument 110 and from the light produces an image 420 of optical detector 140 viewable via viewing device 415. In one embodiment, viewing device 415 is a device onto which image 420 is projected, such as but not limited to a screen. In one embodiment, viewing device 415 is a device for viewing the image directly with a human eye, such as but not limited to an optical eyepiece. After referencing a fixed location on a fixed surface, a baseline azimuth and elevation of image 420 on viewing device 415 is measured. Alignment device 410 can then be removed and optical instrument 110 used as desired. To determine if any subsequent misalignment of optical detector 140 has occurred, alignment device 410 is again positioned to receive collimated light 160 exiting optical instrument 110, as described above. The azimuth and elevation of the resulting image 420 on viewing device 415 is again measured and compared to the baseline azimuth and elevation. Deviations in the image from the baseline position indicate when optical detector 140, or another optical element within the optical instrument, has shifted.

FIG. 4B is a flow chart illustrating a method for verifying optical detector alignment, as described with respect to FIG. 4A above. The method begins at 450 with illuminating a light emitting device located on an optical detector of a collimated optical instrument, such as optical instrument 110. In one embodiment, the collimated light is viewed directly by an alignment device, such as a theodolite, which produces and image of the optical detector (455). The method proceeds to 460 with measuring a baseline azimuth and elevation of the image with respect to a fixed reference point. To subsequently determine the degree of any lateral shift of the optical detector from the baseline measurements, the collimated light is again viewed by an alignment device to produce a second image of the optical detector (465). The method then proceeds to 470 with measuring a second azimuth and elevation of the second image of the optical detector. Any shift in the azimuth and elevation of the optical detector image from the baseline measurements indicates a shift in optical detector alignment. Therefore, method 400 continues to 475 with comparing the second azimuth and elevation measurements with the baseline measurement. When the difference in azimuth and elevation measurements indicates an unacceptable misalignment of the optical detector, the instability of the optical detector is corrected at 480. The method is then repeated starting at 450.

FIGS. 5A and 5B illustrate one embodiment of a method for performing a function test of an optical instrument, such as optical instrument 110. A functional test of optical instrument 110 is performed by reflecting light from LED 135 back onto optical detector 140 and observing the output signal produced by optical detector 140. In one embodiment, light from LED 135 is reflected back onto optical detector 140 by second reflective surface 130 as shown in FIG. 5A. In this embodiment, the light received from LED 135 by optical detector 140 is not focused light, but includes light from any direct or indirect reflecting and scattering paths. The output signal from optical detector 140 in response to the stimulus light from LED 135 indicates that optical detector 140 is functional. Such a test is often required to detect instrument anomalies. If the LED output power is known, then the gain of optical detector 140 can be determined by calculating the ratio of optical detector 140 output to LED 135 output. Further, the output signal from optical detector 140 can also serve as functional test stimulus to verify the operability of one or more external devices 510 coupled to receive the output signal from optical detector 140.

FIG. 5B is a flow chart illustrating a method for functionally testing optical instruments of embodiments of the present invention. The method begins at 560 with illuminating a light emitting device located on an optical detector of an optical instrument, such as optical instrument 110. The light from the light emitting device serves as a stimulus for verifying the operability of the optical detector. The method continues at 562 with reflecting the light from the LED back onto the optical detector. Some quantity of light will be reflected back to the optical detector through indirect reflections and scattering from internal surfaces within the optical instrument. In one embodiment, the LED light is directed back to the optical detector by one or more reflective surfaces. Method 550 proceeds to 564 with measuring one or more output signals from the optical detector. When no output signal is received in response to the LED light, that indicates the optical detector is not functional. Reception of an output signal in response to the LED light indicates that the optical detector is functioning. In one embodiment, the gain of the optical detector is determined with the method by comparing the optical detector output signal with the LED output power. In another embodiment the method further comprises applying the optical detector output signal to one or more external devices to verify the operability of those devices.

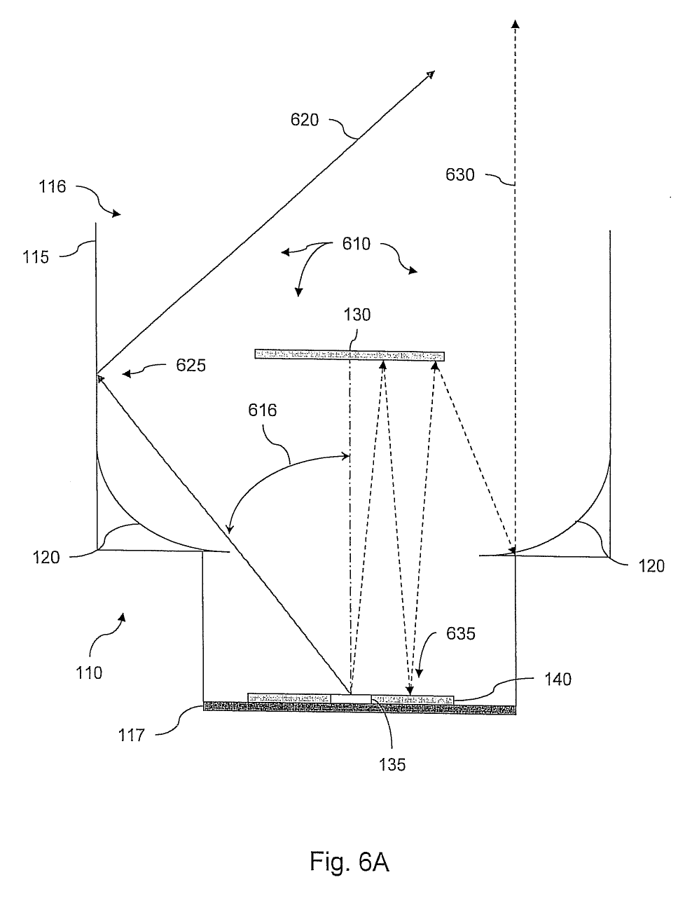

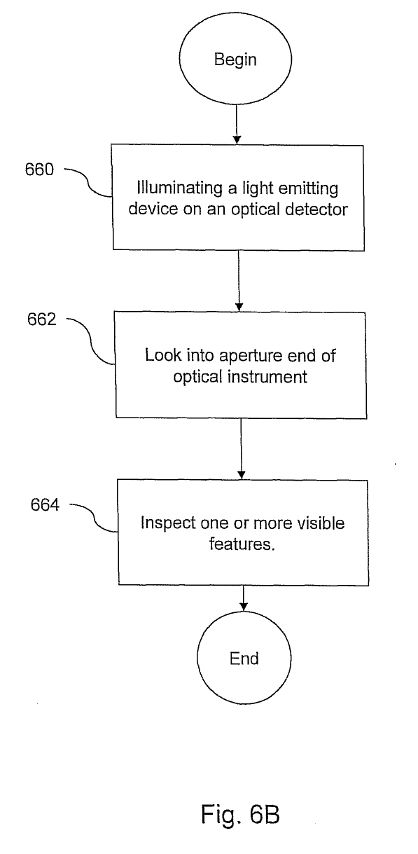

FIGS. 6A and 6B illustrate one embodiment for visually inspecting internal structures within an optical instrument, such as optical instrument 110. By flooding the interior area 610 of optical instrument 110 with light from LED 135, an observer peering into aperture end 116 can perform a visual inspection without the need for a flashlight, lamp or other external light source. For example, in one embodiment, reflected light 620 from LED 135 illuminates an area 625 on an interior surface of tubular housing 115. In one embodiment, reflected light 630 from LED 135 illuminates and area 635 of optical detector 140. Visual details of areas 625 and 635 can be inspected by observing reflected light 620 and 630, respectively. As would be appreciated by one skilled in the art upon reading this specification, it is not unusual for light sources to emit light based on a Lambertian Distribution. In that case the intensity of light emitted from LED 135 will diminish as a function of the cosine of an angle to the normal of optical detector 140 (shown at 616).

FIG. 6B is a flow chart illustrating a method for visually inspecting the internal area of an optical instrument of embodiments of the present invention. Visual inspections allow inspectors to identify anomalies within the optical instrument such as, but not limited to, cracked, broken, or physically degraded components or the existence of one or more foreign materials. In one embodiment, light reflected from intentionally designed reflective surfaces are used to measure alignments and alignment shifts. The method begins at 660 with illuminating a light emitting device located on an optical detector of an optical instrument, such as optical instrument 110. Light emitted from the light emitting device will flood the interior of the optical instrument allowing the interior to be visually inspected by looking through the aperture end of the optical device (662). Which internal features are visible depends on the angle at which the inspector looks into the aperture end. The method then proceeds at 664 with inspecting one or more visible features within the optical instrument to identify one or more anomalies.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. An optical instrument, the instrument comprising:
a tubular housing having an aperture end and an observing end, wherein the aperture end is adapted to allow light to enter and exit the tubular housing;
at least one optical element for focusing light, wherein the at least one optical element for focusing light is adapted to focus collimated light entering the aperture end at a focal point;
an optical detector adapted to receive the focused collimated light; and
a light emitting device coupled to the optical detector and located at the focal point.

2. The instrument of claim 1, wherein the at least one optical element comprises one or both of a first reflective surface and an optical lens.

3. The instrument of claim 1, wherein the first reflective surface comprises a parabolic mirror.

4. The instrument of claim 1, wherein when the at least one optical element for focusing light comprises a first reflective surface and a second reflective surface adapted to reflect light received from the first reflective surface onto the optical detector.

5. The instrument of claim 1, wherein the optical detector is adapted to output one or more signals representing one or more of luminosity and chrominance of light received by the optical detector.

6. A method for testing an optical instrument, the method comprising:
illuminating a light emitting device located on an optical detector at a focal point of an optical instrument, the optical instrument having an aperture end adapted to allow light to enter and exit the optical instrument.

7. The method of claim 6, further comprising:
determining a degree of collimation of light exiting the aperture end of the optical instrument; and
adjusting the position of the optical detector until an acceptable degree of collimation is achieved.

8. The method of claim 7, further comprising:
measuring an elevation of light exiting the aperture end at two or more locations; and
determining the degree of collimation based on differences in the measured elevations.

9. The method of claim 6, the method further comprising:
reflecting collimated light exiting the aperture end back into the aperture end of the optical instrument to form an image of the light emitting device on the optical detector;
varying an angle of the light reflected back into the optical instrument to redirect the image on the optical detector to one or more locations on the optical detector; and
measuring a luminosity of light received by the optical detector at the one or more locations.

10. The method of claim 6, the method further comprising:
reflecting collimated light exiting the aperture end back into the aperture end of the optical instrument to form an image of the light emitting device on the optical detector;
measuring a baseline luminosity of light received by the optical detector;
measuring a baseline elevation angle of a first reflecting surface used to reflect the collimated light back into the optical instrument with respect to a fixed reference;
reflecting collimated light exiting the aperture end back into the aperture end of the optical instrument with a reflective surface oriented to the baseline elevation angle;
measuring a second luminosity of light received by the optical detector; and
comparing the baseline luminosity to the second luminosity to determine when the optical detector has shifted.

11. The method of claim 10, the method further comprising:
adjusting the position of the optical detector.

12. The method of claim 6, the method further comprising:
producing an image of at least one of the optical detector and the light emitting device based on a received collimated light;
measuring a azimuth and elevation of the image with respect to a fixed reference point; and
comparing the measured azimuth and elevation of the image to a baseline azimuth and elevation to determine when a shift in optical detector alignment has occurred.

13. The method of claim 12, the method further comprising:
adjusting the alignment of the optical detector.

14. The method of claim 6, the method further comprising:
reflecting light emitted from the light emitting device back onto the optical detector;
measuring one or more output signals from the optical detector; and
determining when the optical detector is functional based on the one or more output signals.

15. The method of claim 14, further comprising:
determining the gain of the optical detector.

16. The method of claim 15, wherein determining the gain of the optical detector further comprises:
comparing the optical detector output signal with an output power of the light emitting device.

17. The method of claim 14, further comprising:
applying the optical detector output signal to one or more external devices coupled to the optical detector; and
determining the operability of the one or more external devices based on the response of the one or more external devices to the optical detector output signal.

18. The method of claim 6, the method further comprising:
looking through the aperture end of the optical device; and
visually inspecting one or more viable features within the optical instrument.

19. The method of claim 18, further comprising:
identifying one or more anomalies based on the visual inspection of the one or more viable features.

20. The method of claim 18, further comprising:
measuring light from one or more reflective surfaces to determine one or more of alignments and alignment shifts.

21. The method of claim 6, the method further comprising:
receiving collimated light exiting the aperture end of the optical instrument with a second optical instrument; and
testing the second optical instrument based on the collimated light received.

22. An optical instrument, the instrument comprising:
means for collecting within a housing light from a distant light source;
means for focusing the collected light from the distant light source at a focal point within the housing;
means for detecting the light collected from the distant light source and focused at the focal point within the housing; and
means for emitting light at the focal point within the housing for testing the optical instrument.

23. The instrument of claim 22 further comprising:
means for generating one or more signals representing one or both of luminosity and chrominance of one or both of collected light from the distant light source and light from the means for emitting light at the focal point.

24. The instrument of claim 22 further comprising:
means for adjusting the means for detecting based on the means for emitting light.
